(19) United States
(12) Patent Application Publication
(10) Pub. No.: US 2016/0104386 A1
(43) Pub. Date: Apr. 14, 2016

(54) PRODUCT ASSEMBLY ASSISTANCE EMPLOYING TAGGED COMPONENTS

(71) Applicant: EMPIRE TECHNOLOGY DEVELOPMENT LLC, Wilmington, DE (US)

(72) Inventor: Ezekiel Kruglick, Poway, CA (US)

(21) Appl. No.: 14/894,999

(22) PCT Filed: Jun. 5, 2013
(86) PCT No.: PCT/US13/44324

§ 371 Date: Dec. 1, 2015

(51) Int. Cl. G09B 5/00; G09B 19/00; G09B 5/04; G09B 5/06; H04W 4/00; G09B 5/02

(52) U.S. Cl. CPC G09B 5/00; H04W 4/008; G09B 5/02; G09B 5/04; G09B 5/06; G09B 19/00

(57) ABSTRACT

Technologies are generally described for providing instructional media for assembly of a product from multiple components. In some examples, a standalone or web-based application for assisting with assembly of items may be informed of the state of the ongoing unpacking and/or assembly through optically, wirelessly, or comparably readable tags associated with the individual components of a disassembled item. Based on received data on state of assembly and which parts a user is accessing, the application may select appropriate instructional media, including detection of when assembly has gone wrong in order to coach the user through the assembly process and/or corrections.

### BACKGROUND

Unless otherwise indicated herein, the materials described in this section are not prior art to the claims in this application and are not admitted to be prior art by inclusion in this section.

Consumers often buy a product in a disassembled state and assemble at home, office, or similar location. The product may include prepackaged instructions, and instructional videos may also be provided that the consumer may view on a client device such as a television, laptop, smart phone, or tablet device. However, a disassembled product may have many components and small parts, and it may be difficult and confusing for consumers to properly assemble the product. Errors in assembly may be costly, inconvenient, and burdensome for the consumer and for a product supplier. A partially assembled product may not be returnable because of missing components, damage to the product, and it may be inefficient for the product supplier to manage returns of partially assembled products because missing or wrongly connected parts may result in high employee hours for disassembly and verification. Talking someone through assembling a three dimensional object over the telephone, however, may often be difficult and made harder by the difficulty of understanding the implicit assumptions made by someone who assumes, for example, that they have the right bag of screws or the right bundle of supports that is being discussed. Companies invest in web efforts such as online instructions and support tools (for example, live chat support) because small early errors in assembly may result in increased cost and degraded customer experience.

### SUMMARY

The following summary is illustrative only and is not intended to be in any way limiting. In addition to the illustrative aspects, embodiments, and features described above, further aspects, embodiments, and features will become apparent by reference to the drawings and the following detailed description.

The present disclosure generally describes computer-implemented methods for providing instructional media for assembly of a product from a plurality of components. The method may include receiving data that may be effective to identify a component among the plurality of components, identifying the component based on the received data, and providing instructional media associated with an assembly of the product based at least in part on the identification of the component.

The present disclosure also describes a computing device configured to provide interactive instructional media for assembling components of a product. The computing device may include a memory configured to store instructions, and a processor configured to execute an application for providing interactive product assembly instructions in conjunction with the instructions stored in the memory. The application may be configured to receive data that may be effective to identify a component among the plurality of components, identify the component based on the received data, and provide instructional media associated with an assembly of the product based at least in part on the identification of the component.

The present disclosure further describes a computer readable memory device with instructions stored thereon for providing interactive instructional media for assembling components of a product. The instructions may include receiving data that may be effective to identify a component among the plurality of components, identifying the component based on the received data, and providing instructional media associated with an assembly of the product based at least in part on the identification of the component.

The present disclosure also describes a part for assembly into a product including a component for assembly into a product in combination with one or more other components, and a tag, the tag effective to identify the component and to identify a state of assembly of the component, where the tag may be configured to be updated when the state of assembly of the component may be changed.

The present disclosure further describes a disassembled product for assembly employing tagged components. The product may include two or more components to be assembled into the product, and a tag associated with each of the two or more components, the tag effective to identify the respective component and to identify a state of assembly of the component, where the tag may be configured to be updated when the state of assembly of the component may be changed.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system where providing interactive instructional media associated with assembly of a product may be implemented;

FIG. 2 illustrates an example of an assembly of multiple tagged components:

FIG. 3 illustrates an example schematic for providing interactive instructional media for assembling tagged components of a product;

FIG. 4 illustrates a general purpose computing device, which may be used to provide interactive instructional media for assembling tagged components of a product;

FIG. 5 is a flow diagram illustrating an example method that may be performed by a computing device such as the computing device in FIG. 4; and

FIG. 6 illustrates a block diagram of an example computer program product;

all arranged in accordance with at least some embodiments as described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn to methods, apparatus, systems, and/or devices related to providing interactive instructional media for assembling tagged components of a product.

Briefly stated, technologies are generally described for providing instructional media for assembly of a product from multiple components. In some examples, a standalone or web-based application for assisting with assembly of items may be informed of the state of the ongoing unpacking and/or assembly through optically, wirelessly, or comparably readable tags associated with the components of a disassembled product. Based on received data on state of assembly and which parts a user is accessing, the application may select appropriate instructional media. Selection may include detection of when assembly has gone wrong in order to coach the user through the assembly process and/or corrections.

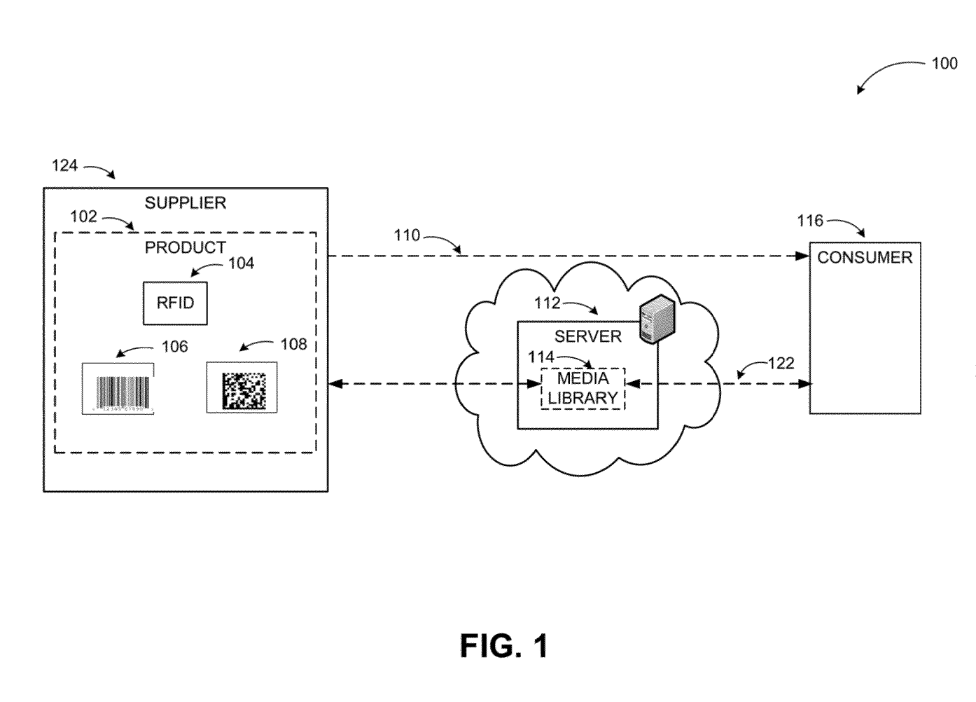

FIG. 1 illustrates an example system, where providing interactive instructional media associated with assembly of a product may be implemented, arranged in accordance with at least some embodiments as described herein.

As illustrated in diagram 100, a consumer 116 may receive (110) a product 102 in a disassembled state from a product supplier 124. The product 102 may include multiple components (104, 106, and 108), which may be tagged to identify each of the components. Identification data associated with the tagged components may be sent to a server 112 associated with the product supplier 124 through scanning the tags (optically, wirelessly, or through similar mechanisms). Alternately, the product supplier may store data associated with the tags at server 112 before the product is made available for sale. Supplier-side scanning may not be needed, as tags may often be generated using a software algorithm and then applied on the product components. Thus, customer-side scanning may suffice. The server 112 may host a database 114 of instructional media associated with product assemblies, and instructional media associated with the identified component may be selected from the instructional media database 114 and provided (122) to the consumer 116 to instruct the consumer 116 on correct assembly of the product 102.

In an example embodiment, the consumer 116 may receive the product 102 in a disassembled state from the supplier 124, and the consumer 116 may assemble the product 102 at home. Some example products that may be received in a disassembled state may include toys, electronic devices, appliances, tools, fixtures, and furniture. The example products are not intended to be limiting, but are presented as examples of products that may include multiple components and may be provided to a consumer in a disassembled state. The components (104, 106, 108) of the product 102 may include a variety of parts and subcomponents of the product, and may also include hardware, such as nuts, bolts, and screws, for assembling the components of the product 102. The components may be tagged in order to identify components of the product. For example, components may be tagged with a radiofrequency identification (RFID) tag, a barcode, a quick reference (QR) tag, a near field communication (NFC) tag, or similar identification tag.

When the consumer 116 receives the product 102 or at any stage of the assembly process, the consumer 116 may scan one or more components to identify the components and/or their state of assembly. The consumer 116 may scan the components employing an optical reader, an RFID reader, a near field tag reader, or similar device. In some examples, a reader application executed on a client device such as a smart phone or tablet may be used to interrogate the tag(s). The reader may be configured to scan an RFID tag, a barcode, a QR tag, an NFC tag, or similar tag integrated with or attached to each component to receive identification data for the scanned component. The identification data for the scanned component may be transmitted to the server 112 associated with the product supplier 124 through one or more wired or wireless networks. Upon receiving the component identification and/or assembly state information, the server 112 may provide suitable instructional media to the consumer 116. The instructional media from database 114 (media library) may include interactive instructional feedback providing real-time assembly instructions to the consumer 116 based on how the consumer 116 interacts with the components of the product 102. Thus, the instructional media may be streamed real-time or downloaded to the consumer's client device. For example, the interactive instructional media may be provided based on an identified active component the consumer 116 is currently interacting with. The interactive instructional media may also be based on a detected assembly state of the product 102 including steps and progress of the assembly.

Example instructional media may include video instructions, graphic instructions, audio instructions, textual instructions, or a combination thereof. The instructional media may be viewed on a user identified client device of the consumer 116, such as a smart phone, tablet, or laptop device. Additionally, the instructional media may be output to an output device associated with the consumer's client device such as a display, a speaker, a printer, or other similar peripheral device.

In another example embodiment, a product assembly application may facilitate scanning the components, providing component identification information to the server, and receiving/presenting the instructional media. The product assembly application may be executed on a client device, such as a smart phone or tablet, associated with the consumer 116. The product assembly application may also be executed on the server 112 associated with the supplier 102 and the consumer 116 may access the product assembly application for receiving the instructional media through a web-browser or a client application executed on the consumer's client device. In yet another example embodiment, the server 112 may receive assembly information associated with scanned components, and associated instructional media may be provided to a customer support representative associated with the product supplier who may provide assembly instructions to the consumer over a telephone call or web-based chat, for example. In further examples, the part or all of the instructional media may be stored locally on the consumer's client device. For example, an assembly assistance application may be provided by the product manufacturer, seller, or a third party for consumers to install on their own client devices. The application may include a pre-loaded media library, and the application may select suitable instruction media upon scanning by the consumer and present the selected media based on component identification/assembly state.

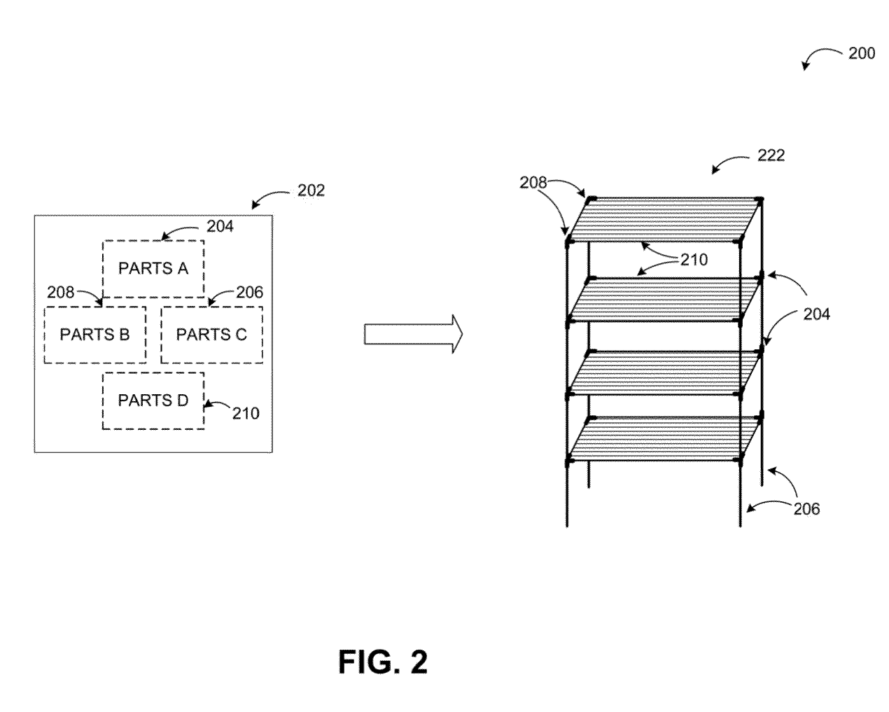

FIG. 2 illustrates an example of an assembly of multiple tagged components, arranged in accordance with at least some embodiments as described herein.

As demonstrated in diagram 200, a disassembled product 202 may include multiple components (204, 206, 208, and 210) that may be packaged together in packs, such as Parts A, Parts B, Parts C, and Parts D. Instructional media may be provided to a consumer to facilitate assembly of the components (204, 206, 208, 210) together into an assembled product 222 (bookcase). Each of the components (204, 206, 208, 210) may be tagged with an identifying marker such as an RFID tag, QR tag, barcode, or NFC tag, as previously described.

In a system according to embodiments, a product assembly application may facilitate providing interactive instructional media associated with each of the components 204, 206, 208, 210 (for example, shelves and bars of the bookcase) of the disassembled product 202. The instructional media may be based on a detected component and a detected assembly state of the bookcase. An active component and an assembly state may be detected employing a reader to retrieve identification information for each tagged component. The reader may be executed on the consumer's client device, and the reader may actively or passively scan components of a product. For example, the reader may actively scan a component when the consumer manually scans the component with the reader. The reader may be configured to passively scan components when the reader is placed in close vicinity to the component. When the reader passively scans the components, the reader may continuously identify components and determine an assembly state of the identified components, in order to enable instructional media to be provided.

In an example embodiment, the instructional media may be provided based on a detected active component to provide instructions related to the active component. For example, when the consumer initially unpacks a component from the box, the unpacked component may be scanned and identified as an active component. Instructional media may be provided for providing initial instructions for the unpacked component. Example initial instructions may include instructions for how and when the component will be used during assembly. Additionally, the instructional media associated with an active component may indicate that the active component is not needed until later, and may provide instructions to select a different component for beginning an assembly.

In a system according to embodiments, the instructional media may also be provided based on a determined assembly state of the product. The assembly state may be determined based on the scanned identification data for multiple components. The instructional media provided based on the determined assembly state may include instructions relevant to assembly of the selected component(s) at the determined assembly state. The instructional media may instruct the consumer, for example, to select additional components related to the determined state of assembly, and may provide instructions on how to assemble the components together. The product assembly application may also be configured to confirm if the consumer has selected the proper components, based on receiving the identification information for the selected components. Upon confirming selection of proper components, instructional media may be provided for assembly of the selected components. Furthermore, if the consumer selects an incorrect component for the determined state of assembly, the consumer may be notified that the selected component is incorrect based on received identification information for the scanned incorrect component.

A stage of assembly of a product and a state of assembly of one or more components, as used herein, refer to distinct items. Stage of assembly, essentially captures that the product is assembled stage-by-stage from multiple components, and that some of the components may be themselves assembled step-by-step from subcomponents, in a nested assembly method. State of the assembly refers to an assembly state of a component. For example, whether the component is coupled with/inserted into/attached to another component. The state of assembly of a component may be correct or faulty resulting in different actions by a system according to embodiments. An assembly state may include a standalone state, an intermediate assembly state, a final assembly state, or a faulty assembly state. In an example scenario, when a state of the component is identified as a standalone state and/or an intermediary state, instructional media may be provided for a next step of assembly of the product. In another example, when the state of the component is identified as the faulty assembly state, instructional media for a corrective step of assembly of the product may be selected and provided. In a further example, when the state of the component is identified as the final assembly state, instructional media for a next component identification step of assembly of the product may be provided.

In some examples, sensors may be integrated with the components of the product to facilitate identification of the assembly state and steps of assembly for the product components. For example, sensors integrated with a component may indicate a state of the assembly, including when components have been assembled together with one or more other components. The sensors may also be configured to indicate if and when components have been assembled incorrectly. A component may include one or more sub-components, and the sensors may be configured to detect the state of assembly of the component based on a connection state of one or more sub-components. Sensors integrated with the sub-components of the component may be configured to detect the state of assembly of the component based on whether the component is coupled with one or more other components. Some example sensors may include resistive sensors, light sensors, proximity sensors, inductive sensors, and an electrical circuit.

For example, resistive sensors may be configured to detect the state of assembly of the component based on a measured resistance. The resistive sensors may measure a resistance across individual components (for example, shelves and bars of the bookcase), and if an expected resistance of coupled components is not within an acceptable range, then the consumer may be notified that the components are coupled together incorrectly. Light sensors may be configured similarly to indicate proper connection of components by emitting and detecting a light, which may be blocked and extinguished when the components are coupled together correctly. Light sensors may also be employed to detect when a component is unwrapped and removed from packaging to indicate that the component is active. Proximity sensors may be employed to detect if a component is placed in a correct location and orientation. Furthermore, an inductive sensor may be employed (for example, with metal components) to detect when the component is unwrapped and removed from packaging to indicate that the component is active. An inductive sensor may also sense a change in inductive properties of a component to determine if the components are properly connected together. An inductive sensor may include a wire wrapped around a screw or bolt hole, and when a connector is inserted within the hole, the changes may allow for sensing of fastener positioning. The sensors may be integrated into or coupled with the tags. Alternatively, an electrical circuit may also be employed to update the tag on the component state based on the detected state of assembly of the component. Any of the sensors discussed above and a variety of other suitable sensors may also be used in conjunction with one or more RFID tags, where the sensors may be connected to the RFID tags and sensor input can be read from the RFID tags.

In a further embodiment, an alteration of the identification tags may be employed for identifying a state of assembly of one or more components. For example, the tags, such as the RFID tag, or the NFC tag, QR code, or barcode may identify an individual component, and when two or more components are coupled together, the tags may be altered to provide new identification information. In the case of RFID tags, one or more of the tags in an assembled state may be disabled (for example, covered by a component or have an antenna disabled). In the case of optical tags such as barcodes, one or more of the barcodes may again be covered by a portion of a component as a result of the assembly and the barcode not covered may be used to determine the state. Moreover, the optical tags may be positioned such that correct assembly of the components may result in combination of the tags providing different information to a reader compared to the tags being scanned individually. If the component is assembled incorrectly, then the scanned information may indicate improper assembly or a faulty assembly state.

In an example embodiment, a faulty assembly state may be detected when a component is assembled in an incorrect position, location, and/or orientation, or when two or more components are connected together incorrectly. When the state of the component is identified as faulty, instructional media for a corrective step of assembly of the component may be selected and provided. Instructional media for the corrective step of assembly may include instructions on disassembling the faulty component and re-assembling the component correctly. The instructional media for the corrective step may also include instructions for selecting a correct component if an incorrect component was selected by the consumer.

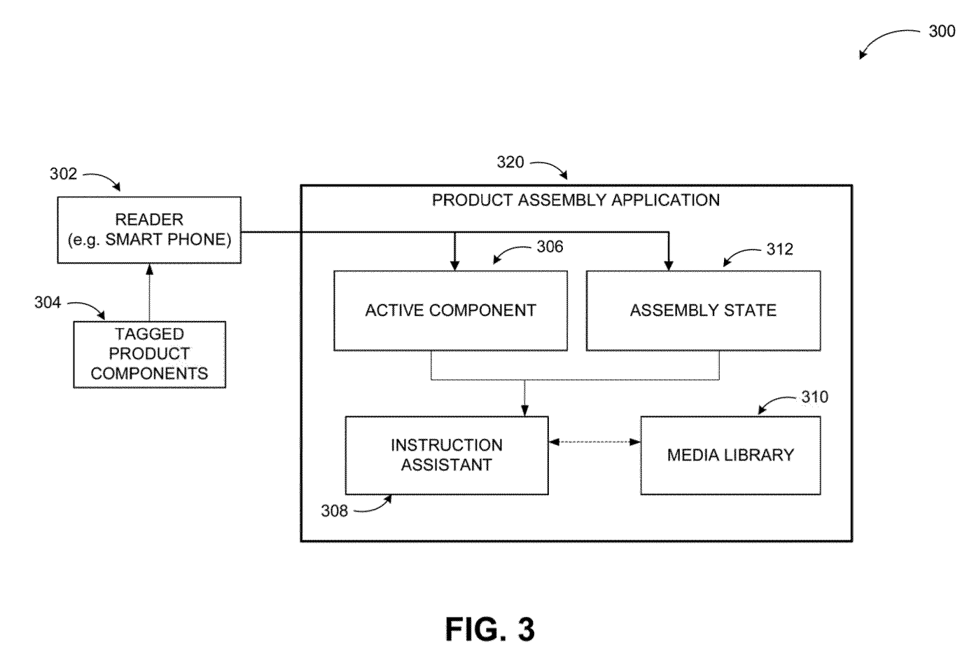

FIG. 3 illustrates an example schematic for providing interactive instructional media for assembling tagged components of a product, arranged in accordance with at least some embodiments as described herein.

As illustrated in diagram 300, a product assembly application 320 may facilitate presentation of instructional media for assembling components of a product to a consumer. The product assembly application 320 may be a standalone application executed a consumer client device, such as a smart phone or tablet device. The product assembly application 320 may also be a remote application accessed, for example, through a web-browser or a client application.

In a system according to embodiments, a disassembled product may include multiple components 304, and each component may be tagged with one or more of an RFID tag, a QR tag, a barcode, an NFC tag, or similar tag to identify the component. Yet, in other examples, only some components may be tagged (for example, major components, groups of components, or components that have complex or non-standard assembly procedures). When a consumer receives and begins assembly of the product, the consumer may employ a reader 302 to scan each component to retrieve the identification information for the tagged components 304. The reader may be a separate device (for example, provided along with the disassembled product) or an application executed on the consumer's client device, such as a smart phone or tablet. The reader may communicate the scanned component identification information to the product assembly application 320, which may be local or hosted on a remote server.

In some examples, identification information for the component(s) may be received by the product assembly application 320 when the consumer scans a tagged component. The product assembly application 320 may identify the component as an active component 306, indicating that the consumer is currently interacting with the identified component. Additionally, the product assembly application 320 may identify an assembly state 312 of the active component, such as which step in the assembly process the consumer is currently working on, based on the identification of the active component.

The product assembly application 320 may provide the determined active component 306 and assembly state 312 information to an instruction assistant 308 for selecting and providing instructional media to the consumer. The instruction assistant 308 may access a media library 310 of instructional media, and may select instructional media relevant to the active component 306 and/or the assembly state 312. As discussed previously, example instructional media related to the active component 306 may include instructions for how the component is to be used and assembled during the assembly process. Instructional media may be provided during an initial unpacking of the component. Instructional media related to the assembly state 312 of the component may include instructions for a step of the assembly process including the active component 306.

The assembly state may include a standalone assembly state, an intermediary assembly state, a final assembly state, and a faulty assembly state, as some examples. If a standalone assembly state and/or intermediary assembly state is detected, then the instruction assistant 308 may select instructional media for a next step of assembly. The instructional media may instruct the consumer to select a particular tagged component needed for the next step of assembly, and upon detecting a scanning of the new tagged component, the new tagged component may be identified as an active component, and instructional media for the new active component may be provided, as well as instructional media for the next step of assembly employing the new active component.

Further, if a faulty assembly state is detected, the instruction assistant 308 may select instructional media for instructing the consumer how to disassemble the component and re-assemble the component properly. A faulty assembly state may be detected when a component is assembled incorrectly, placed in an incorrect position and/or orientation, and when the component is coupled with one or more other components improperly. Sensors integrated with the component and sub-components may facilitate detecting a faulty assembly state.

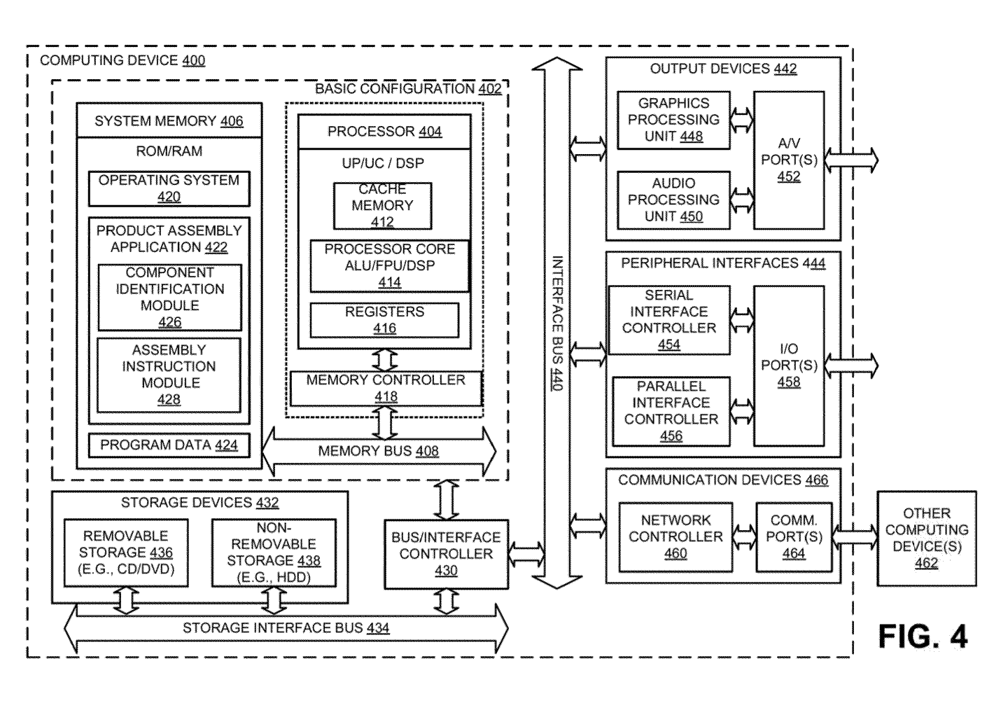

FIG. 4 illustrates a general purpose computing device, which may be used to provide interactive instructional media for assembling tagged components of a product, arranged in accordance with at least some embodiments as described herein.

In a very basic configuration 402, computing device 400 typically includes one or more processors 404 and a system memory 406. A memory bus 408 may be used for communicating between processor 404 and system memory 406.

Depending on the desired configuration, processor 404 may be of any type including but not limited to a microprocessor (μP), a microcontroller (μC), a digital signal processor (DSP), or any combination thereof. Processor 404 may include one more levels of caching, such as a level cache memory 412, a processor core 414, and registers 416. Example processor core 414 may include an arithmetic logic unit (ALU), a floating point unit (FPU), a digital signal processing core (DSP Core), or any combination thereof. An example memory controller 418 may also be used with processor 404, or in some implementations memory controller 418 may be an internal part of processor 404.

Depending on the desired configuration, system memory 406 may be of any type including but not limited to volatile memory (such as RAM), non-volatile memory (such as ROM, flash memory, etc.) or any combination thereof. System memory 406 may include an operating system 420, a product assembly application 422, and program data 424. The product assembly application 422 may include a component identification module 426 that is arranged to read a tagged component of a disassembled product to identify an active component and an assembly state of the active component. The product assembly application 422 may also include an assembly instruction module 428 that may be configured to provide instructional media related to the identified active component and the assembly state of the active component. Program data 424 may include the active component data and assembly state data retrieved from tags and sensors integrated with the tagged components. This described basic configuration 402 is illustrated in FIG. 4 by those components within the inner dashed line.

Computing device 400 may have additional features or functionality, and additional interfaces to facilitate communications between basic configuration 402 and any needed devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436 and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

Computing device 400 may also include an interface bus 440 for facilitating communication from various interface devices (for example, output devices 442, peripheral interfaces 444, and communication devices 446) to basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (for example, keyboard, mouse, pen, voice input device, touch input device, etc.) or other peripheral devices (for example, printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a personal computer including both laptop computer and non-laptop computer configurations. Moreover computing device 400 may be implemented as a networked system or as part of a general purpose or specialized server or client device.

Example embodiments may also include methods. These methods can be implemented in any number of ways, including the structures described herein. One such way is by machine operations, of devices of the type described in the present disclosure. Another optional way is for one or more of the individual operations of the methods to be performed in conjunction with one or more human operators performing some of the operations while other operations are performed by machines.

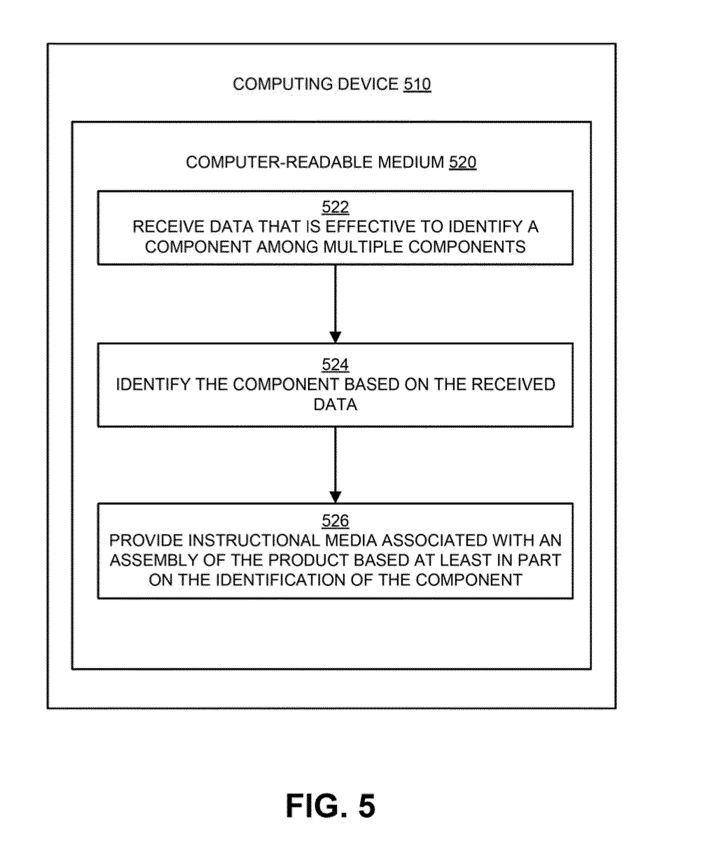

FIG. 5 is a flow diagram illustrating an example method that may be performed by a computing device such as the computing device in FIG. 4, arranged in accordance with at least some embodiments as described herein.

Example methods may include one or more operations, functions or actions as illustrated by one or more of blocks 522, 524, and/or 526. The operations described in blocks 522 through 526 may also be stored as computer-executable instructions in a computer-readable medium such as computer-readable medium 520 of computing device 510.

A process for providing interactive instructional media for assembly of a product may begin with block 522, “RECEIVE DATA THAT IS EFFECTIVE TO IDENTIFY A COMPONENT AMONG MULTIPLE COMPONENTS.” At block 522, a product assembly application may receive identification data from a tagged component of a disassembled product. A disassembled product may include multiple components, and each component may be tagged with one or more of an RFID tag, QR tag, NFC tag, barcode or similar tag to identify the component. A reader may be employed to scan the component to receive the identification data from the tag, and the identification data may be received by the product assembly application.

Block 522 may be followed by block 524, “IDENTIFY THE COMPONENT BASED ON THE RECEIVED DATA.” At block 524, the product assembly application may identify the component based on the received identification data. The component may be identified as an active component, and additionally, the product assembly application may identify a stage and state of assembly (that is the assembly status of the product and connection status of individual components or groups of components) based on the received identification data of the tagged component.

Block 524 may be followed by block 526, “PROVIDE INSTRUCTIONAL MEDIA ASSOCIATED WITH AN ASSEMBLY OF THE PRODUCT BASED AT LEAST IN PART ON THE IDENTIFICATION OF THE COMPONENT.” At block 526, the product assembly application may select instructional media relevant to the identified active component and assembly state. The instructional media may be one or more of a video instruction, an audio instruction, a graphic instruction and/or a text instruction for demonstrating how to assemble the active component. The instructional media may also indicate when a component has been assembled incorrectly, and may provide instructions for a next step of assembly after a component has been assembled correctly.

The blocks 522 through 526 may be performed by a product assembly application 422 executed by the processor 404 of computing device 400 shown in FIG. 4, for example. The blocks may be performed by separate modules or applications.

The blocks included in the above described process are for illustration purposes. Providing interactive instructional media for assembly of a product may be performed by similar processes with fewer or additional blocks. In some examples, the blocks may be performed in a different order. In some other examples, various blocks may be eliminated. In still other examples, various blocks may be divided into additional blocks, or combined together into fewer blocks.

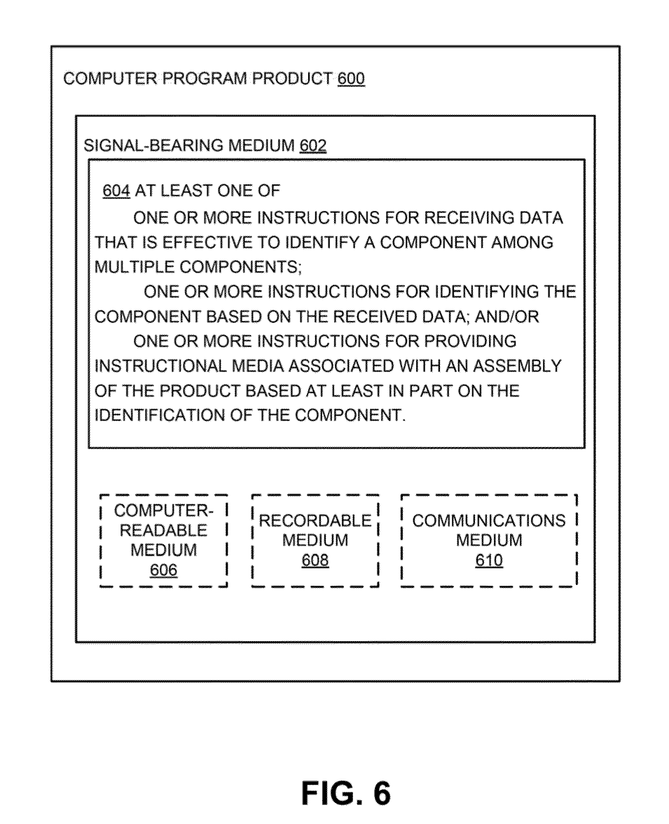

FIG. 6 illustrates a block diagram of an example computer program product, arranged in accordance with at least some embodiments as described herein.

In some embodiments, as shown in FIG. 6, the computer program product 600 may include a signal bearing medium 602 that may also include one or more machine readable instructions 604 that, when executed by, for example, a processor may provide the functionality described herein. Thus, for example, referring to the processor 404 in FIG. 4, an assembly instruction module 428 executed on the processor 404 may undertake one or more of the tasks shown in FIG. 6 in response to the instructions 604 conveyed to the processor 404 by the medium 602 to perform actions associated with providing interactive instructional media for assembly of a product as described herein. Some of those instructions may include, for example, instructions for receiving data that is effective to identify a component among the plurality of components, identifying the component based on the received data, and/or providing instructional media associated with an assembly of the product based at least in part on the identification of the component, according to some embodiments described herein.

In some implementations, the signal bearing medium 602 depicted in FIG. 6 may encompass a computer-readable medium 606, such as, but not limited to, a hard disk drive, a solid state drive, a Compact Disc (CD), a Digital Versatile Disk (DVD), a digital tape, memory, etc. In some implementations, the signal bearing medium 602 may encompass a recordable medium 608, such as, but not limited to, memory, read/write (R/W) CDs, R/W DVDs, etc. In some implementations, the signal bearing medium 602 may encompass a communications medium 610, such as, but not limited to, a digital and/or an analog communication medium (for example, a fiber optic cable, a waveguide, a wired communications link, a wireless communication link, etc.). Thus, for example, the program product 600 may be conveyed to one or more modules of the processor 404 of FIG. 4 by an RF signal bearing medium, where the signal bearing medium 602 is conveyed by the wireless communications medium 610 (for example, a wireless communications medium conforming with the IEEE 602.11 standard).

According to some examples, the present disclosure describes a computer-implemented method for providing instructional media for assembly of a product from a plurality of components. The method may include receiving data that may be effective to identify a component among the plurality of components, identifying the component based on the received data, and providing instructional media associated with an assembly of the product based at least in part on the identification of the component.

According to some examples, the method may include receiving data from a Radio Frequency Identification (RFID) tag or a Near Field Communication (NFC) tag associated with the component. The method may include receiving data produced by scan of a Quick Response (QR) code or a barcode associated with the component. Receiving data further comprises receiving data that may be effective to identify a stage of assembly of the product. The method may include identifying the stage of assembly of the product based on the received data.

According to some examples, selecting instructional media may also include selecting instructional media based at least in part on the identification of the stage of assembly of the product. Receiving data further comprises receiving data that may be effective to identify a state of the component. The method may include identifying the state of the component based on the received data.

According to other examples, identifying the state of the component may also include identifying the state of the component as one of a standalone state, an intermediate assembly state, a final assembly state, or a faulty assembly state. Providing instructional media may also include providing instructional media for a step of assembly of the product associated with the component. Providing instructional media may also include selecting instructional media based on the state of the component, and providing the selected instructional media for a step of assembly of the product associated with the component.

According to other examples, selecting instructional media may also include selecting instructional media for a next step of assembly of the product, when the state of the component may be identified as the standalone state or the intermediate assembly state. Selecting instructional media may also include selecting instructional media for a corrective step of assembly of the product, when the state of the component may be identified as the faulty assembly state. Selecting instructional media may also include selecting instructional media for a next component identification step of assembly of the product, when the state of the component may be identified as the final assembly state.

According to other examples, providing instructional media may also include transmitting instructional media to a user-identified client device. Providing instructional media comprises providing one or more of an instruction video, an instruction audio, an instruction graphic, and or an instruction text. The product may include one or more of: a toy, an electronic device, an appliance, a fixture, a tool, hardware, and a piece of furniture.

According to some examples, the present disclosure also describes a computing device configured to provide interactive instructional media for assembling components of a product. The computing device may include a memory configured to store instructions, and a processor configured to execute an application for providing interactive product assembly instructions in conjunction with the instructions stored in the memory. The application may be configured to receive data that may be effective to identify a component among the plurality of components, identify the component based on the received data, and provide instructional media associated with an assembly of the product based at least in part on the identification of the component. The application may be further configured to receive data from a Radio Frequency Identification (RFID) tag or a Near Field Communication (NFC) tag associated with the component.

According to some examples, the application may be further configured to receive data produced by scan of a Quick Response (QR) code or a barcode associated with the component. The application may be further configured to receive data that may be effective to identify a stage of assembly of the product. The application may be further configured to identify the stage of assembly of the product based on the received data.

According to some examples, the application may be further configured to select instructional media based at least in part on the identification of the stage of assembly of the product. The application may be further configured to receive data that may be effective to identify a state of the component. The application may be further configured to identify the state of the component based on the received data. The application may be further configured to identify the state of the component as one of a standalone state, an intermediate assembly state, a final assembly state, or a faulty assembly state.

According to some other examples, the application may be further configured to provide instructional media for a step of assembly of the product associated with the component. The application may be further configured to select instructional media based on the state of the component, and provide the selected instructional media for a step of assembly of the product associated with the component. The application may be further configured to select instructional media for a next step of assembly of the product, when the state of the component may be identified as the standalone state or the intermediate assembly state. The application may be further configured to select instructional media for a next component identification step of assembly of the product, when the state of the component may be identified as the final assembly state.

According to other examples, the computing device may be a server and the application may be further configured to transmit instructional media to a user-identified client device. The computing device may be a user-identified client device, and the instructional media associated with the assembly of the product may be provided through an output device associated with the computing device.

According to other examples, the output device associated with the computing device may include one or more of: a display, a speaker, a printer, and a peripheral device. The instructional media may include one or more of an instruction video, an instruction audio, an instruction graphic, and or an instruction text.

According to some examples, the present disclosure also describes a computer readable memory device with instructions stored thereon for providing interactive instructional media for assembling components of a product. The instructions may include receiving data that may be effective to identify a component among the plurality of components, identifying the component based on the received data, and providing instructional media associated with an assembly of the product based at least in part on the identification of the component.

According to some examples, receiving data may include receiving data from a Radio Frequency Identification (RFID) tag or a Near Field Communication (NFC) tag associated with the component. Receiving data may include receiving data produced by scan of a Quick Response (QR) code or a barcode associated with the component. Receiving data may include receiving data that may be effective to identify a stage of assembly of the product. The instructions may include identifying the stage of assembly of the product based on the received data.

According to some examples, selecting instructional media may include selecting instructional media based at least in part on the identification of the stage of assembly of the product. Receiving data may include receiving data that may be effective to identify a state of the component. The instructions may include identifying the state of the component based on the received data.

According to other examples, identifying the state of the component may include identifying the state of the component as one of a standalone state, an intermediate assembly state, a final assembly state, or a faulty assembly state. Providing instructional media may include providing instructional media for a step of assembly of the product associated with the component. Providing instructional media may include selecting instructional media based on the state of the component, and providing the selected instructional media for a step of assembly of the product associated with the component.

According to other examples, selecting instructional media may include selecting instructional media for a next step of assembly of the product, when the state of the component may be identified as the standalone state or the intermediate assembly state. Selecting instructional media may include selecting instructional media for a corrective step of assembly of the product, when the state of the component may be identified as the faulty assembly state. Selecting instructional media may include selecting instructional media for a next component identification step of assembly of the product, when the state of the component may be identified as the final assembly state.

According to other examples, providing instructional media may include transmitting instructional media to a user-identified client device. The computer readable memory device may be a user-identified client device. The user-identified client device may include one or more of: a smart phone, a tablet, and where the assembly instructions may be provided by an application locally installed on the user-identified client device.

According to further examples, the computer readable memory device may be a remote server configured to receive assembly data and to provide the assembly instructions through a web-based application. The remote server may be configured to receive assembly data and to provide the assembly instructions to a customer service representative, and where the customer service representative provides the assembly instructions to the user.

According to other examples, the present disclosure further describes a part for assembly into a product including a component for assembly into a product in combination with one or more other components, and a tag, the tag effective to identify the component and to identify a state of assembly of the component, where the tag may be configured to be updated when the state of assembly of the component may be changed.

According to some examples, the state of assembly of the component may be one of a standalone state, an intermediate assembly state, a final assembly state, or a faulty assembly state. The tag may be one or more of a Radio Frequency Identification (RFID) tag, a Near Field Communication (NFC) tag, a Quick Response (QR) code or a barcode.

According to some examples, the part also may include a sensor configured to detect the state of assembly of the component, and update the tag, based on the detected state of assembly of the component. The sensor may also include one or more of a resistive sensor, a light sensor, a proximity sensor or an inductive sensor. The sensor may further include an electrical circuit, and where the electrical circuit may be configured to update the tag based on the detected state of assembly of the component. The sensor may further include a resistive sensor, and where the resistive sensor may be configured to detect the state of assembly of the component based on a measured resistance.

According to some examples, the component may include one or more sub-components and the sensor may be configured to detect the state of assembly of the component based on a connection state of one or more sub-components. The sensor may be configured to detect the state of assembly of the component based on whether the component may be coupled with one or more other components.

According to other examples, the present disclosure further describes a disassembled product for assembly employing tagged components. The product may include two or more components to be assembled into the product, and a tag associated with each of the two or more components, the tag effective to identify the respective component and to identify a state of assembly of the component, where the tag may be configured to be updated when the state of assembly of the component may be changed.

According to some examples, the state of assembly of the component may be one of a standalone state, an intermediate assembly state, a final assembly state, or a faulty assembly state. The tag may be one or more of a Radio Frequency Identification (RFID) tag, a Near Field Communication (NFC) tag, a Quick Response (QR) code or a barcode.

According to some examples, the product may include a sensor configured to detect the state of assembly of the two or more components, and update the tag, based on the detected state of assembly of the two or more components. The sensor may include one or more of a resistive sensor, a light sensor, a proximity sensor or an inductive sensor. The sensor further may include an electrical circuit, where the electrical circuit may be configured to update the tag based on the detected state of assembly of the two or more components.

According to other examples, the sensor may include a resistive sensor, and where the resistive sensor may be configured to detect the state of assembly of the component based on a measured resistance. The sensor may be configured to detect the state of assembly of the two or more components based on whether a component may be coupled with one or more other components.

### Example 1

### Barbeque Grill Assembly

A consumer may purchase a propane gas barbeque grill from an online store, and the store may ship the grill in an unassembled state to the consumer's home. Each unassembled component of the grill may be barcoded to identify the component. The store may provide a barcode scanner in the shipping package to allow the consumer to scan each component. The consumer may connect the barcode scanner to their tablet or smart phone device, and the barcode scanner may communicate with a store server to provide identification information related to the scanned components to the server. The server may return multimedia instructions in form of graphics and text related to the assembly of each scanned component to the consumer's tablet. After completion of the assembly, the consumer may return the barcode scanner in a provided pre-stamped and addressed package.

### Example 2

### Tracking Assembly of a Multimedia System

A consumer may receive a multimedia system from a local electronics store. The multimedia system may include multiple parts and connecting components such as cords and wireless connecting devices. Each part may be RFID tagged, and an RFID scanner may be provided by the electronics store to assist in the assembly and set up of the system. The consumer may visit the store website on the consumer's laptop, and may select the system in order to navigate to a series of instructions for the system assembly. The RFID tags on the components may include optical sensors strategically placed such that when two components are connected properly, the optical sensor cannot detect light. The RFID tags may also be configured to update based on an output of the light sensor. The RFID scanner may scan the tags on the components as the user assembles the device determining which component is currently being used and the current assembly state of the system. The scanned information may be communicated to a server associated with the website providing the instructions. The instructions in form of video segments related to the scanned components and assembly state may be streamed in real-time to the consumer's laptop. If an assembly error is detected through the scanning of a tag with a light sensor, corrective instructions may be provided by the website. After a detection of corrected mistake, further instructions may be streamed related to a next step of assembly. When finished the consumer may return the RFID scanner to the store to receive an incentive (for example, a discount coupon).

### Example 3

### Smart Phone Application for Assisting in Assembly of Furniture

A baby's crib may be shipped to a consumer from an online retailer. Each part of the crib may be tagged with a QR code. The online retailer may provide instructions for installing an application associated with the retailer and a QR code scanner application on the consumer's smart phone. The consumer may scan a component with the QR code scanner application, and the retailer application may provide video instructions related to the scanned component on the consumer's smart phone. The instructions, which may be downloaded to the smart phone at the beginning of the assembly process to allow offline use of the assembly assistance, may describe which other component and hardware is needed to connect two components, and may instruct the consumer to scan the components again after assembly to confirm a correct selection. Upon confirmation of correct component selection, video instructions may be provided on the smart phone to demonstrate proper assembly.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the an that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (for example, feedback for sensing position and/or velocity of gantry systems; control motors for moving and/or adjusting components and/or quantities).

A typical data processing system may be implemented using any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (fir example, the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various compositions, methods, systems, and devices are described in terms of “comprising” various components or steps (interpreted as meaning “including, but not limited to”), the compositions, methods, systems, and devices can also “consist essentially of” or “consist of” the various components and steps, and such terminology should be interpreted as defining essentially closed-member groups.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A computer-implemented method for providing instructional media for assembly of a product from a plurality of components, the method comprising:
receiving data that is effective to identify a state of a component among the plurality of components;
identifying the state of the component based on the received data;
selecting instructional media based on the state of the component; and
providing the selected instructional media associated with an assembly of the product based at least in part on the identification of the state of the component to a user-identified client device.

2. The method of claim 1, wherein receiving data comprises:
receiving data from a Radio Frequency Identification (RFID) tag, a Near Field Communication (NFC) tag, a Quick Response (QR) tag or a barcode associated with the component.

3.-4. (canceled)

5. The method of claim 1, further comprising:
identifying a stage of assembly of the product based on the received data.

6. The method of claim 5, wherein selecting instructional media comprises:
selecting instructional media based at least in part on the identification of the stage of assembly of the product.

7.-8. (canceled)

9. The method of claim 1, wherein identifying the state of the component comprises:
identifying the state of the component as one of a standalone state, an intermediate assembly state, a final assembly state, or a faulty assembly state.

10.-12. (canceled)

13. The method of claim 1, wherein selecting instructional media comprises:
selecting instructional media for a corrective step of assembly of the product, when the state of the component is identified as the faulty assembly state.

14.-15. (canceled)

16. The method of claim 1, wherein providing instructional media comprises providing one or more of an instruction video, an instruction audio, an instruction graphic, and or an instruction text.

17. (canceled)

18. A computing device configured to provide interactive instructional media for assembling components of a product, the computing device comprising:
a memory configured to store instructions; and
a processor configured to execute an application for providing interactive product assembly instructions in conjunction with the instructions stored in the memory, wherein the application is configured to:
receive data that is effective to identify a state of a component among the plurality of components;
identify the state of the component based on the received data;
select instructional media based on the state of the component; and
provide the selected instructional media associated with an assembly of the product based at least in part on the identification of the state of the component to a user-identified client device.

19.-20. (canceled)

21. The computing device of claim 18, wherein the application is further configured to:
receive data that is effective to identify a stage of assembly of the product.

22.-28. (canceled)

29. The computing device of claim 18, wherein the application is further configured to:
select instructional media for a next step of assembly of the product, when the state of the component is identified as the standalone state or the intermediate assembly state.

30. (canceled)

31. The computing device of claim 18, wherein the computing device is a server.

32. The computing device of claim 18, wherein the computing device is a user-identified client device, and the instructional media associated with the assembly of the product is provided through an output device associated with the computing device.

33. The computing device of claim 32, wherein the output device associated with the computing device includes one or more of: a display, a speaker, a printer, and a peripheral device.

34. (canceled)

35. A computer readable memory device with instructions stored thereon for providing interactive instructional media for assembling components of a product, the instructions comprising:
receiving data that is effective to identify a stage of assembly of the product;
identifying the stage of assembly of the product based on the received data;
selecting instructional media based on stage of assembly of the product; and
providing the selected instructional media associated with an assembly of the product based at least in part on the identification of the stage of assembly of the product to a user-identified client device.

36.-40. (canceled)

41. The computer readable memory device of claim 35, wherein receiving data further comprises receiving data that is effective to identify a state of the component.

42.-44. (canceled)

45. The computer readable memory device of claim 41, wherein providing instructional media comprises:
selecting instructional media based on the state of the component; and
providing the selected instructional media for a step of assembly of the product associated with the component.

46.-47. (canceled)

48. The computer readable memory device of claim 45, wherein selecting instructional media comprises:
selecting instructional media for a next component identification step of assembly of the product, when the state of the component is identified as the final assembly state.

49.-50. (canceled)

51. The computer readable memory device of claim 35, wherein the user-identified client device includes one or more of: a smart phone, a tablet, and wherein the assembly instructions are provided by an application locally installed on the user-identified client device.

52. The computer readable memory device of claim 35, wherein the computer readable memory device is a remote server configured to receive assembly data and to provide the assembly instructions through a web-based application.

53. The computer readable memory device of claim 52, wherein the remote server is configured to receive assembly data and to provide the assembly instructions to a customer service representative, and wherein the customer service representative provides the assembly instructions to the user.

54.-70. (canceled)
